(19) United States
(12) Patent Application Publication
(10) Pub. No.: US 2016/0110453 A1
(43) Pub. Date: Apr. 21, 2016

(54) SYSTEM AND METHOD FOR SEARCHING CHOREOGRAPHY DATABASE BASED ON MOTION INQUIRY

(71) Applicant: Electronics and Telecommunications Research Institute, Daejeon (KR)

(72) Inventors: Do Hyung KIM, Daejeon (KR); Jae Hong KIM, Daejeon (KR); Nam Shik PARK, Daejeon (KR); Min Su JANG, Daejeon (KR); Mun Sung HAN, Daejeon (KR); Cheon Shu PARK, Daejeon (KR); Sung Woong SHIN, Daejeon (KR)

(21) Appl. No.: 14/667,058

(22) Filed: Mar. 24, 2015

(30) Foreign Application Priority Data
Oct. 16, 2014 (KR) 10-2014-0139569

(51) Int. Cl. G06F 17/30; G06K 9/00

(52) U.S. Cl. CPC G06F 17/30793; G06K 9/00744; G06K 9/00758; G06K 9/00342

(57) ABSTRACT

The present invention provides a choreography searching system and method based on a motion inquiry which inputs a choreography video which is captured by a user at real time when the user dances in front of a camera and inputs the choreography video as an inquiry to compare the choreography with choreographic works such as K-POP stored in a choreography database to provide a list of choreographic works which are arranged in the order of similarity in order to provide intuitive choreography input based search rather than text based search such as a music title, a choreographer, or a name of a unit motion.

### CROSS-REFERENCE TO RELATED APPLICATIONS

This application claims priority to and the benefit of Korean Patent Application No. 10-2014-0139569 filed in the Korean Intellectual Property Office on Oct. 16, 2014, the entire contents of which are incorporated herein by reference.

### TECHNICAL FIELD

The present invention relates to a choreography searching system and method, and particularly, to a choreography searching system and method based on a motion inquiry which inquires a choreography video to search works (contents) such as K-POP related with the choreography from a choreography database.

### BACKGROUND ART

In accordance with an international music trend which is changed from listening to music to watching music, K-POP is spread through an on-line video service such as YouTube all over the world including not only Asia and the Pacific area but also America and Europe. A core driving force which has spread K-POP all over the world is K-POP dancing and all the K-POP songs which are in the upper ranks of the number of hits on the website YouTube are dance music including a choreography video.

Demands for a contents service which utilizes the K-POP dance are rapidly being increased all over the world and creating an explosive market, and economical ripple effect in view of economy are expected in the future. Presently, it was predominantly analyzed that global spread of the K-POP is impossible if an IT technology which is represented by an on-line video service and a smart phone is not provided and a new IT technology power needs to be created in order to consistently spread and maintain the K-POP phenomenon in the future.

However, even though the K-POP dance is one of the core elements of a third Korean wave, an IT based related technology and data for spreading related contents to the global market have not been secured and scientific and systematic studies for spreading lessons for motions of K-POP dance are insufficient currently. Since most K-POP dance data is currently simple video data, it is difficult to reuse the K-POP dance data in various services or recreate a secondary work.

Profits achieved from the K-POP dance contents are advertising revenue obtained by releasing a music video and a performance video through a YouTube video sharing service but are insufficient to create a large amount of industrial added value. Demands for learning or copying the K-POP dance are explosive all over the world but producing, but efforts to produce the contents, the contents popular for lesson and spread of the K-POP dance is insufficient. Currently, since a system for distributing and utilizing the choreography motion has never been created, when a company wants to utilize the K-POP dance motion data, the company needs to create the K-POP dance motion by itself or create the K-pop dance motion by a specialized company so that a cost is huge. Further, since a copyright system for choreography has not been established, it is highly likely that a legal conflict against a creator of the choreography may occur.

Choreography is emerging as an essential element of global success of the K-POP, so that a choreography copyright calls attention to the public opinion and a social awareness for the choreography copyright is changed through a case that a royalty for utilizing the choreography is paid. In 2012, a domestic court ruled to admit the choreography copyright, which provides grounds for legislation for choreography copyright protection. In 2015, it is expected that a choreography copyright associate for choreography copyright protection is established and it is also expected that the legislation for the choreography copyright may provide to build a K-POP dance related technology and data ecosystem which may accelerate the secondary works, the service development and commercialization by spreading the choreography data.

However, according to a choreography related searching technology of the related art, the choreography is searched based on a text, such as music title or a choreographer. When the choreography has a name of a unit motion such as ballet, dance, or taekwondo, the search service is provided using the name of the unit motion. Therefore, it is required to improve the choreography related searching technology in order to utilize the choreography related copyright in various ways.

### SUMMARY OF THE INVENTION

The present invention has been made in an effort to provide a choreography searching system and method based on a motion inquiry which inputs a choreography video which is captured by a user at real time when the user dances in front of a camera and inputs the choreography video as an inquiry to compare the choreography with choreographic works (contents) such as K-POP stored in a choreography database to provide a list of choreographic works which are arranged in the order of similarity in order to provide intuitive choreography input based search rather than text based search such as a music title, a choreographer, or a name of a unit motion.

Features of the present invention will be summarized. An exemplary embodiment of the present invention provides a motion inquiry based searching method in a motion inquiry based searching service device including storing video data for a plurality of (choreography) contents and search reference information in a database; analyzing the input motion inquiry video to extract position information for joints of an inquirer in every video frame; extracting a representative posture describer of the inquirer for every section based on posture describers extracted from the position information for joints of the inquirer; extracting the representative posture describer of contents for every point section referring to the search reference information; and comparing the representative posture describer of the inquirer for every section with the representative posture describer of contents for every point section to calculate the similarity and extracting contents including a motion video having the highest similarity from the database.

The motion inquiry video may include a three-dimensional depth video and the position information for joints may include three-dimensional position information.

The search reference information may include position information for joints of a choreographer in the video frame. The search reference information may further include a choreographer posture describer in each video frame for a predetermined every point section and a representative posture describer for the every point section.

The posture describer may include a set of relative angle information between joints.

In the extracting of a representative posture describer of contents for every point section, in order to adjust the joints, the posture describers for contents may be extracted and the representative posture describer of contents for every point section may be extracted after extracting the position information of joints corresponding to each joint in the database based on the data amount of position information for the joints of the inquirer.

The method may further include displaying a content list which is arranged in the order of ranking of similarity on a display device according to the similarity.

The similarity S may be calculated using Equation S=αPS+(1−α) OS, based on a similarity PS of a posture and a similarity OS of the posture matching order and α is a weight which is set in advance.

The similarity PS of a posture may be calculated using a value adding the highest similarity among the representative posture describers of contents for every point section for the representative posture describers of an inquirer for every section, and the similarity OS of the posture matching order may be calculated using an index based on the order of representative posture describer among representative posture describers of the contents for every point section which matches by the highest similarity, for every representative posture describer of the inquirer for every section.

Another exemplary embodiment of the present invention provides a motion inquiry based searching service device, including a data base which stores video data for a plurality of contents and search reference information; a human joint extracting unit which analyzes the input motion inquiry video to extract position information for joints of an inquirer in every video frame; a motion feature extracting unit which extracts a representative posture describer of the inquirer for every section based on posture describers extracted from the position information for joints of the inquirer and extracts the representative posture describer of contents for every point section referring to the search reference information; and a searching unit which compares the representative posture describer of the inquirer for every section with the representative posture describer of contents for every point section to calculate the similarity and extracts contents including a motion video having the highest similarity from the database.

The motion inquiry video may include a three-dimensional depth video and the position information for joints may include three-dimensional position information.

The search reference information may include position information for joints of a choreographer in the video frame. The search reference information may further include a choreographer posture describer in each video frame for a predetermined every point section and a representative posture describer for the every point section. The posture describer may include a set of relative angle information between joints.

In order to adjust the joints, the motion feature extracting unit may extract the posture describers for contents and extract the representative posture describer of contents for every point section after extracting the position information of joints corresponding to each joint in the database, based on the data amount of position information for the joints of the inquirer.

The device may further include a searching result interface which displays a content list which is arranged in the order of ranking of similarity on a display device according to the similarity.

The similarity S may be calculated using Equation S=αPS +(1−α) OS, based on a similarity PS of a posture and a similarity OS of the posture matching order and α is a weight which is set in advance.

The similarity PS of a posture may be calculated using a value adding the highest similarity among the representative posture describers of contents for every point section for the representative posture describers of an inquirer for every section, and the similarity OS of the posture matching order may be calculated using an index based on the order of representative posture describer among representative posture describers of the contents for every point section which matches by the highest similarity, for every representative posture describer of the inquirer for every section.

According to the choreography searching system and method based on a motion inquiry of the present invention, with respect to an inquiry which inputs a choreography video selected by a user or an choreography section video, a list of choreographic works which are arranged in the order of similarity is provided to provide intuitive choreography input based searching service rather than text based search such as a music title, a choreographer, or a name of a unit motion, as compared with the choreography works such as K-POP which is stored in the choreography database.

Therefore, the present invention is utilized as a searching interface for intuitively searching a specific choreography in a dance game device and the choreography may be utilized when a professional choreographer creates a dance choreography by a in a customized copyright supporting system and the choreography copyright is efficiently searched and managed in the choreography copyright searching system.

### BRIEF DESCRIPTION OF THE DRAWINGS

FIG. 1 is a conceptual diagram of a choreography searching system based on a motion inquiry according to an exemplary embodiment of the present invention.

FIG. 2 is a specific block diagram of a searching service device based on a motion inquiry according to an exemplary embodiment of the present invention.

FIG. 3 is a flowchart illustrating an operation of a searching service device based on a motion inquiry according to an embodiment of the present invention.

FIG. 4 is a reference view illustrating general skeleton joints of a human.

FIG. 5 is a view explaining an example of an implementing method of a searching service device based on a motion inquiry according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, the present invention will be described in detail with reference to accompanying drawings. In this case, like components are denoted by like reference numerals in the drawings as much as possible. Further, a detailed description of a function and/or a configuration which has been already publicly known will be omitted. In the following description, parts which are required to understand an operation according to various exemplary embodiments will be mainly described and a description on components which may cloud a gist of the description will be omitted. Some components of the drawings will be exaggerated, omitted, or schematically illustrated. However, a size of the component does not completely reflect an actual size and thus the description is not limited by a relative size or interval of the components illustrated in the drawings.

First, an importance, marketability, and commercializing possibility of a technology of a choreography searching system and method according to the present invention which searches choreography database based on a motion inquiry to provide digital multimedia contents data for similar choreographic works will be described.

### <Importance of Motion Inquiry Based Searching Technology>

It is essential to secure choreography related data (digital multimedia content data) such as a K-POP dance and develop an IT technology based thereon in order to promote and develop a K-POP dance related content industry. A choreography related motion capture database of a high quality K-POP dance is an essential element to create ecology for providing a foundation of a choreography contents industry and is required to be secured without the least delay. Further, an efficient choreography searching system is essential to build a choreography industry ecologic system of the K-POP dance by constructing a choreography copyright environment of the K-POP dance, generating and registering the choreography copyright data, and building a utilizing system. A huge choreography database searching technology is an essential technology for managing choreography related intellectual property of the K-POP dance and leading a related industry. A technology of recording, registering, and searching standardized choreography data is essential to manage a huge amount of intellectual property and lead a related industry which may occur in relation to the choreography such as the K-POP dance through the legislation of the choreography copyright. In order to efficiently refer the choreography data, reuse the choreography, and determine and prevent infringement of the copyright, not only a text based choreography search, but also, easy searching technology which searches the choreography using the motion of the user as a unit of inquiry is required. The motion based choreography searching technology of the present invention is an intuitive and unique technology which creates a choreographic motion as a motion inquiry and searches the choreographic motion using the motion inquiry as an input in order to search a choreography database for a K-POP dance which does not have a name of a unit motion. The technology is different from the related method which searches the motion only using a name of the unit motion such as ballet or Taekwondo. The choreography searching technology which requires delicate comparison of a complex dance motion is a technology having a high level of difficulty whose entry barrier is high and a core common foundation technology which may be utilized in various contents fields.

### <Marketability of Motion Inquiry Based Searching Technology>

A market of K-POP expects sales to continuously increase in accordance with continuous overseas expansion and growth of performing art and a market of motion recognition is expected to reach a high growth rate of 25.6% as of an annual average since 2010 and form a scale of a market of six hundred and twenty million dollars by 2015. Further, with respect to the dancing game, three million (one hundred and fifty million dollars) DVDs of “Dance Central” have been sold and thus “Dance Central” is positioned as a representative game of MS XBOX. The present invention is a core common foundation technology and is determined to expand a choreography work related industry of a K-POP dance, a game, and motion recognition and create a new market.

### <Commercializing Possibility of Motion Inquiry Based Searching Technology>

Legislation of the choreography copyright is expected in the future. Therefore, it is determined standardized choreography data is inevitably recorded, registered, and a searching technology is inevitably developed and commercialized in order to protect the intellectual property and lead the related industry while a new industry will be created in a technology field of searching the choreography copyright, deliberating plagiarism, and building a choreographic work environment.

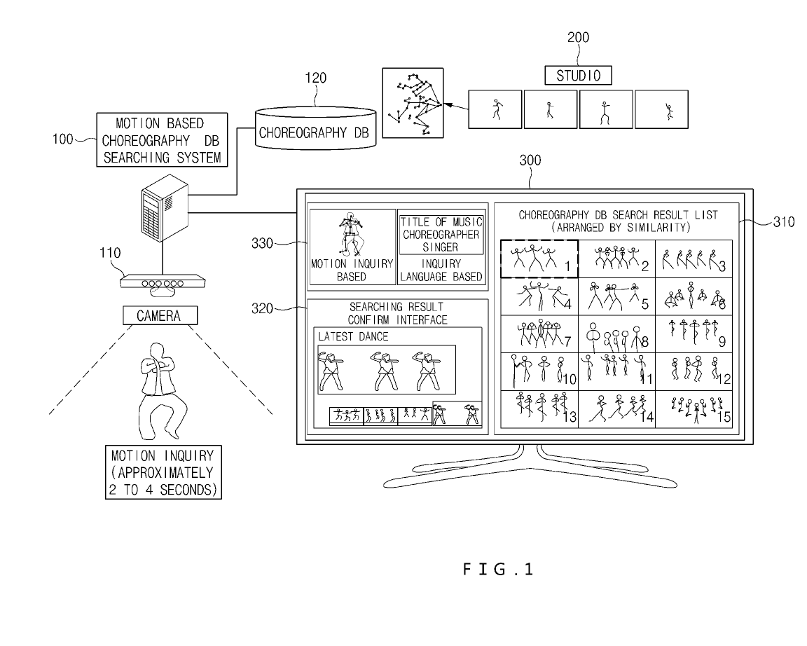

FIG. 1 is a conceptual diagram of a choreography searching system based on a motion inquiry according to an exemplary embodiment of the present invention. Referring to FIG. 1, a motion inquiry based choreography searching system according to an exemplary embodiment of the present invention may include a motion inquiry based searching service device 100, a camera 110, a choreography DB 120, an exclusive motion capture studio 200, and a display device 300.

In the choreography DB 120, a choreography related contents data (digital multimedia contents data) including a choreography video of people, such as a K-POP dance is stored and managed. Such choreography related contents data (or choreography contents) includes a large amount of position information of skeleton joints (or a body part) in accordance with movement of a position of a marker or a sensor in a video frame, in addition to choreography video data and outline information corresponding to the choreography video data such as a title of a music, a choreographer, or a singer.

For example, the choreography data stored in the choreography DB 120 includes search reference information such as a large amount of position information for each skeleton joint (or a body part) in accordance with the movement of the marker or the sensor position in the video frame, which is obtained based on high quality motion capture data obtained by attaching a marker or a sensor to a person who performs choreography for motion capture and precisely processing the movement information of the position of the marker or the sensor generated in accordance with the movement of the people, in addition to the choreography video data such as a K-POP dance obtained by capturing choreography of people using a motion capture apparatus in the studio 200. This becomes the basis to extract a posture descriptor (feature information of a posture) for every point section and representative posture information, which will be described below.

In order to search the choreography, the choreography may be searched based on an inquiry text such as a title of music, a choreographer, or a singer according to the related art, but in the choreography searching system according to the present invention, contents of the choreography DB 120 may be specifically searched based on a motion inquiry.

To this end, the motion inquiry based searching service device 100 receives a motion inquiry video (data) from the camera 110 and searches a choreography content which match or is similar to the motion referring to the choreography DB 120 to display the searching result on the display device 300 such as an LCD or an LED. Here, the camera 110 may be a 3D (three dimension) camera, but the present invention is not limited thereto. In some cases, a 2D (two dimension) camera may be used. For example, a low cost 3D camera such as Kinect by Microsoft Corporation or XTion by ASUS may be used.

For example, when choreography contents including a predetermined motion (or a movement) is searched from several hundred to several thousands of choreography contents such as a large amount of KPOP dances (for example, an amount corresponding to a reproducing time of three minutes to four minutes for one dance) which are stored and managed in the choreography DB 120, an inquirer such as a dancer or a user may perform the choreography motion such as a dancing motion in front of the camera 110 for a predetermined time (for example, two to four seconds). Therefore, the motion inquiry based searching service device 100 which receives the motion inquiry video captured (photographed) by the camera 110 searches the choreography contents including a motion (a movement) which matches or similar to the motion inquiry video input in the choreography DB 120. The motion inquiry based searching service device 100 compares the motion inquiry video input with the entire choreography contents in the choreography DB 120 to list the choreography contents searching result including the coinciding or most similar motion in the order of the ranking of similarity to display the result on the display device 300 as illustrated in FIG. 1.

The motion inquiry based searching service device 100 may provide interfacing information for the searching result and searching control through an interfacing window 320 for providing a reproduction related tool for checking the searching result (checking by the user) such as producing, stopping, and searching the contents when any one of the list is selected, and an interfacing window 330 for providing a searching method type which may be selected (by the user) among various choreography DB 120 searching methods such as a text inquiry input method (a choreography contents searching method by a text command language), a voice inquiry input method (a choreography contents searching method by a voice command language) the motion inquiry video input method, a motion inquiry input method, in addition to the motion inquiry video input method, in addition to an interfacing window 310 for providing a list of choreography contents arranged in the order of similarity rankings to the display device 300 as illustrated in FIG. 1.

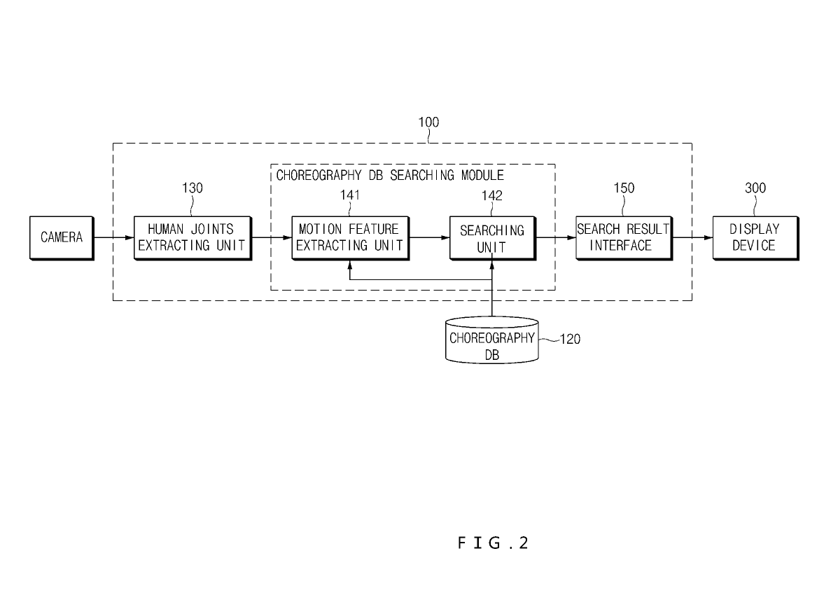

FIG. 2 is a specific block diagram of a motion inquiry based searching service device 100 according to an exemplary embodiment of the present invention.

Referring to FIG. 2, the motion inquiry based searching service device 100 includes a human joint extracting unit 130 which receives a motion inquiry video as an inquiry command language from the camera 110, a searching module 140 which includes a motion feature extracting unit 141 and a searching unit 140 to search the choreography DB 120, and a search result interface 150. In some cases, the motion inquiry based searching service device 100 may include a device for managing the camera 110, the choreography DB 120, the display device 300, and the exclusive motion capture studio 200. Constitutional elements of the motion inquiry based on a searching service device 100 may be implemented by hardware, software, or a combination thereof.

Even though it will be described below that the motion inquiry based searching service device 100 receives the inquiry command language (the motion inquiry video) from the camera 110 to search the choreography contents. However, a still image (a file) or a video (file) which has been obtained from the storing unit is selected to receive the motion inquiry video to search the choreography contents. Further, when the interfacing window which provides the searching method type 330 provided by the searching result interface 150 is provided and the inquiry text and the inquiry voice are input as an inquiry command language by the selection of the user, the searching module 140 searches the choreography DB 120 in accordance with the inquiry command language, and the searching result interface 150 processes the choreography contents searching result to be displayed on the display device 300 in the form of interfacing windows 31, 320, and 330.

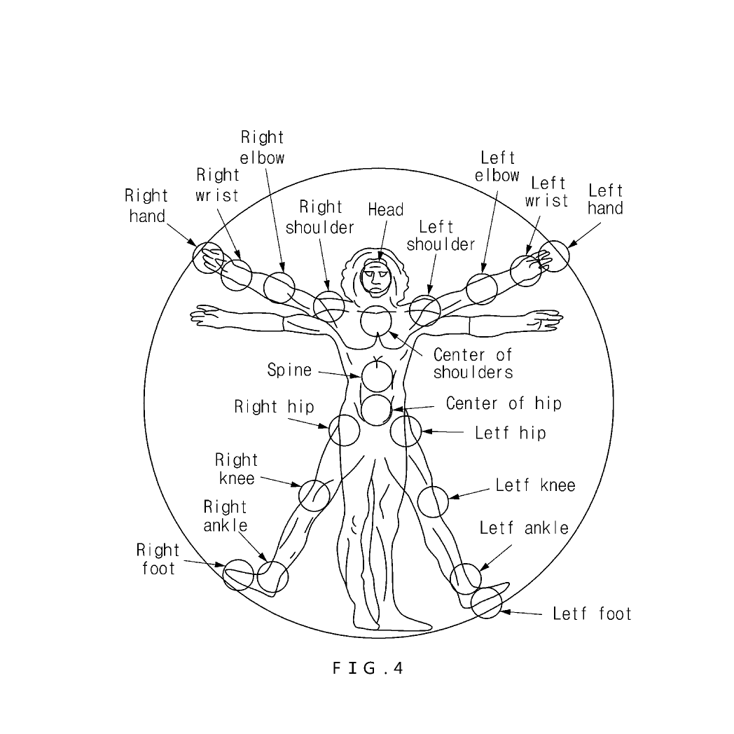

When the inquiry motion video (data) of the inquirer or the user is input from the camera 110, the human joint extracting unit 130 analyzes the motion inquiry video to detect joints (for example, head, shoulder, hands, wrist, elbow, rib, hip, knee, ankle, or foot) which configure a skeleton of a human as illustrated in FIG. 4 and traces 3D position (x, y, z) information of the detected joints. Here, the input motion inquiry video may be a three-dimensional depth image (data) including a distance (or a depth) information (z axis information) which is generated using the 3D camera. In this case, a two dimensional RGB (red, green, and blue) video which is generated using the 3D camera may be referred or may not be referred. Further, in some cases, when the input motion inquiry image is a two-dimensional image which is generated using a 2D camera, the human joint extracting unit 130 may trace 2D position (x, y) information of the joints from the image and estimates the z-axis information in accordance with a predetermined algorithm to trace the 3D position (x, y, z) information of the joints. Here, the human joint extracting unit 130 may use units to perform various video analyzing algorithms such as a human joint extracting engine in order to detect the joints from the video.

In the searching module 140, the motion feature extracting unit 141 extracts the feature information of a posture of the inquirer or the user in each frame of the motion inquiry video with respect to position information of the analyzed human joints and extracts representative posture information for every section which is divided based on a predetermined standard and also extracts a choreographer posture describer (feature information of the posture) in each video frame with respect to the position information of the joints of the choreography DB 120 and extracts representative posture information for every point section by a predetermined standard.

In the searching module 140, the searching unit 142 compares the representative posture information for every section of the motion inquiry video which is extracted as described above with the representative posture information for every point section of the choreography contents of the choreography DB 120 to extract a choreography content including a choreography which is the most similar to the motion inquiry motion from the choreography DB 120. For example, the searching unit 142 may extract the choreography contents for every section in which a similarity between representative posture information for every section of the motion inquiry and the choreography contents for every point section managed by the choreography DB 120 is high.

The searching result interface 150 processes the choreography contents searching result which is extracted from the searching module 140 to display the choreography contents list which is aligned in the ranking order of similarity on the display device 300 in the form of interfacing windows 31, 320, and 330.

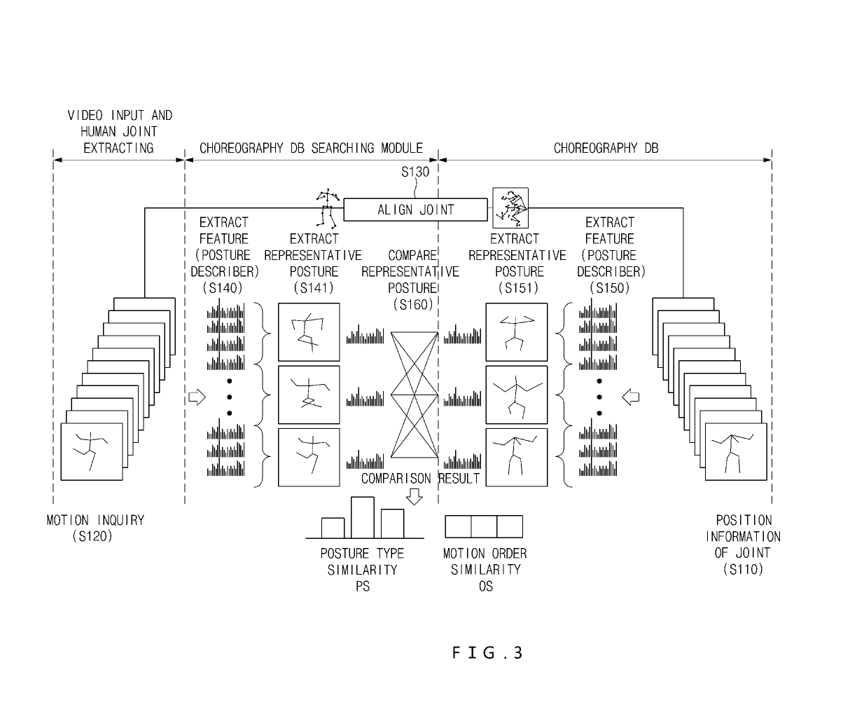

FIG. 3 is a flowchart explaining an operation of the motion inquiry based searching service device 100 according to an exemplary embodiment of the present invention.

First, as described above, the choreography contents stored in the choreography DB 120 is high quality motion capture data obtained by attaching several tens of markers or sensors onto each joint (or a body part) of the choreographer (dancer) and photographing using an expensive and exclusive motion capture device and includes search reference information such as a large amount of position information of skeleton joints (or a body part) in accordance with movement of positions of markers or a sensor (for example, 30 to 80) in a video frame, in addition to choreography video data in step S110.

In contrast, when the inquiry motion video (data) is input from the camera 110, the human joint extracting unit 130 analyzes the motion inquiry video to detect joints (for example, head, shoulder, hands, wrist, elbow, rib, hip, knee, ankle, or foot) which configure a skeleton of a human as illustrated in FIG. 4 from the video frame and traces position information (for example, 3D position (x, y, z) information) of the joints detected from the video frame in step S120.

Here, the position information of joints of the video frame for choreography contents stored in the choreography DB 120 is high quality or high precision information which is obtained using lots of markers and sensors but the human joint extracting unit 130 analyzes a three-dimensional depth image input from the low cost 3D camera to extract position information of just 15 to 20 joints.

Therefore, in the searching module 140, the motion feature extracting unit 141 may selectively perform the joint adjustment for position information of two joints whose precision level or relative position is different in step S130, before extracting the feature information of the posture. That is, the motion feature extracting unit 141 may adjust the position information of the joints for the choreography contents stored in the choreography DB 120 and the position information of the joints which is analyzed from the motion inquiry video which is input from the camera 110, to have the same data amount. For example, based on the data amount of the position information of the joints analyzed from the motion inquiry video input from the camera 110, joints position information corresponding to the joints (a predetermined name) is extracted from the choreography DB 120 and the remaining data is removed to extract the feature information of the postures.

That is, in the searching module 140, the motion feature extracting unit 141 extracts feature information (posture describer) of a posture of the inquirer or the user in each frame of the motion inquiry image with respect to the position information of the human joints analyzed in the human joint extracting unit 130 in step S140, extracts the representative posture information (for example, feature information of the representative posture such as a posture of upwardly extending the right hand or a posture of bending the left leg) for every section which is divided based on a predetermined standard (for example, time or posture) in step S141, extracts the choreographer posture describer (feature information of the posture) in each video frame with respect to the joints position information of the choreography DB 120 in step S150, and extracts the representative posture information for every point section divided by a predetermined reference (for example, a time, a posture) in step S151. For example, contents such as a KPOP dancing music have a section (for example, a popular choreography or refrain) corresponding to two to four point choreographies and the point choreography may be a main searching target in the searching module 140. The point section which is the main searching target is preferentially searched, but the searching range may extend to a portion other than the point section by a setting at any time.

When original choreography contents are stored in the choreography DB 120, a point section determined in accordance with a predetermined section, a choreographer posture describer (feature information of the posture) in each video frame for every point section of the contents (a choreography video such as a music video, a dance video, an educational dance routine), and the representative posture information for every point section (feature information of the representative posture) are extracted in advance to be further stored as search reference information and the searching unit 142 may use the information.

In the searching module 140, when the choreographer posture describer (feature information of the posture) is extracted from the position information of the joints of the choreography DB 120 or the posture describer (feature information of the posture) which is stored in the choreography DB 120, the posture describer may be formed of a set of relative angle information (for example, an angle formed by a left shoulder and a left elbow) between joints. That is, 360 degrees are divided into k angle sections and an angle formed by two joints may be determined by one of the k angle sections. Angle information in the combinations between joints is determined as one of k angle sections to finally generate a histogram representing a frequency at which k angles for every section to be used to determine similarity.

As described above, when a feature extracting step which extracts a posture describer for all frames included in a specific section is completed in steps S140 and 150, a step of extracting representative posture information which represents the choreography section among postures included in the specific section is performed in steps S141 and S151. Here, the representative posture may be extracted by a process of clustering posture describers which are extracted in the order of time into several groups. For example, a well-known clustering technique, such as a hierarchical method, an optimal disassembly method, a model based method, and a neural network method, is used to classify postures included in the specific section into a plurality of groups and sets a posture which is the closest to an average of the groups as a representative posture. As described above, choreography contents data is divided into a plurality of specific point sections and the choreography in the specific point section may be represented by posture describers of the extracted representative posture. The representative posture describers may be stored and managed in the choreography DB 120 as search reference information together with original choreography video data to be compared with the posture describers of the choreography which is analyzed in the human joint extracting unit 130 for a motion inquiry for every section input from the low cost camera 110 in the searching module 140.

In the searching module 140, the searching unit 142 compares the representative posture information (describer) for every section of the motion inquiry video which is extracted as described above with the representative posture information (describer) for every point section of the choreography contents of the choreography DB 120 to extract a choreography content including choreography (or motion) video data which is the most similar to the motion inquiry motion from the choreography DB 120 in step S160. That is, through the comparison with respect to the choreography contents, the searching unit 142 may extract choreography contents having a high similarity to the representative posture information (describer) for every section of the inquiry motion and corresponding to the representative posture information (describer) for every point section managed by the choreography DB 120 in the order of ranking of similarity.

For example, the searching unit 141 calculates a finally determined similarity S based on a similarity PS of the posture and a similarity OS of the matching order using Equation 1 so that the choreography content searching result which is extracted in the order of the finally determined similarity S is processed through the searching result interface 150 and a list of choreography contents arranged in the order of ranking of similarity is displayed on the display device 300 in the form of interfacing windows 31, 320, and 330.

S=αPS+(1−α)OS [Equation 1]

Here, α is a weight and a default value thereof is generally 0.5. However, in accordance with the importance between the posture similarity PS and the similarity OS of matching order, α may be set to exceed 0.5 or be below 0.5. When a more weight is applied to the posture similarity PS, for example, when the contents including choreographies which are similar to the motion inquiry are searched, rather than searching a specific contents (for example, a choreography video such as a music video, a dance video, an educational dance routine) in the choreography DB 120, the frequency of the similar postures is a preferred measurement to determine a similarity, rather than the order of the motion inquiry, so that α may be set to be larger than 0.5 (α>0.5). When a more weight is applied to the similarity OS of the posture matching order, for example, when specific contents (for example, a choreography video such as a music video, a dance video, an educational dance routine) in the choreography DB 120 is searched, an order of the motion inquiries is a preferred measurement to determine a similarity, so that a may be set to be smaller than 0.5 (α<0.5).

The representative posture information (describers) for every section for the motion inquiry video extracted by the motion feature extracting unit 141 may be n (natural number) and the representative posture information (describers) for every point section of the choreography contents of the choreography DB 120 extracted by the motion feature extracting unit 141 may be m (natural number).

In this case, the searching unit 142 calculates a similarity of the first representative posture information (describer) of the motion inquiry video with the representative posture information (describer) of m choreography contents in the choreography DB 120 and calculates the highest similarity PS1 among them. Similarly, PS2 to PSn are calculated and a sum thereof or an average value is a posture similarity PS, which becomes a measure indicating how much similar posture is included between the choreography of the motion inquiry and the choreography of the choreography contents of the choreography DB 120.

During the process of calculating the posture similarity PS as described above, the searching unit 142 may extract an index indicating an order of representative posture information (describer), which matches n representative posture information (describers) of the motion inquiry video with the highest similarity, among of m representative posture information (describer) of choreography contents in the choreography DB 120. The index may be foundation for calculating a matching order similarity OS of the posture. For example, a degree of regular increase of the index value is represented by points to calculate the similarity OS of the matching order of the posture.

As described above, the motion inquiry based choreography searching system according to the exemplary embodiment of the present invention compares the representative posture describers for a motion inquiry input from the camera 110 such as a low cost 3D camera with the representative posture describer for specific point sections of the choreography contents data in the choreography DB 120 to output choreography contents including a specific section having the largest similarity S as final matching data.

Constitutional elements or functions thereof of the choreography searching system as described above to implement the choreography searching in accordance with the motion inquiry based choreography searching algorithm according to the exemplary embodiment of the present invention may be implemented by hardware, software, or a combination thereof. Moreover, when constitutional elements or functions according to the exemplary embodiment of the present invention is executed by one or more computer or processor, it may be implemented on the recording medium which may be red by the computer or the processor as a code which may be read by the computer or the processor. The process readable recording medium includes all types of recording devices in which data readable by a processor are stored. Examples of a process readable recording medium include an ROM, a RAM, a CD-ROM, a magnetic tape, a floppy disk, and an optical data storing device and also include a medium which is implemented as a carrier wave such as the transmission through the Internet. Further, the processor readable recording medium is distributed in computer systems connected through a network and the processor readable code is stored therein and executed in a distributed manner.

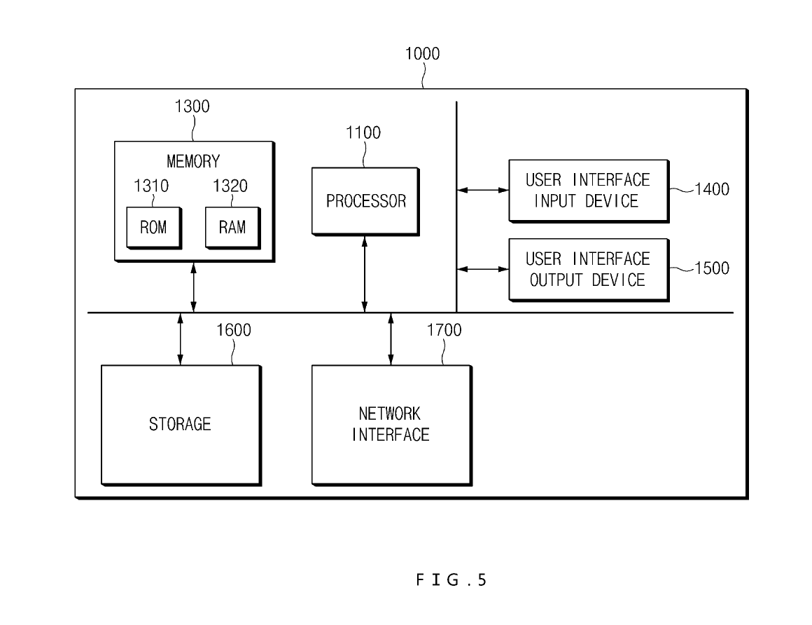

FIG. 5 is a view explaining an example of an implementing method of a searching service device 100 based on a motion inquiry according to an exemplary embodiment of the present invention. Constitutional elements of the motion inquiry based on searching service device 100 according to an exemplary embodiment of the present invention may be implemented by hardware, software, or a combination thereof. For example, the motion inquiry based on searching service device 100 may be implemented by the computing system 1000 as illustrated in FIG. 5.

The computing system 1000 may include at least one processor 1100, a memory 1300, a user interface input device 1400, a user interface output device 1500, a storage 1600, and a network interface 1700 which are connected to each other through a bus 1200. The processor 1100 may be a semiconductor device which may perform processings on commands which are stored in a central processing unit (CPU), or the memory 1300 and/or the storage 1600. The memory 1300 and the storage 1600 may include various types of volatile or non-volatile storage media. For example, the memory 1300 may include a read only memory (ROM) and a random access memory (RAM).

The method or a step of algorithm which has described regarding the exemplary embodiments disclosed in the specification may be directly implemented by hardware or a software module which is executed by a processor 1100 or a combination thereof. The software module may be stored in a storage medium (that is, the memory 1300 and/or the storage 1600) such as a RAM, a flash memory, a ROM, an EPROM, an EEPROM, a register, a hard disk, a detachable disk, or a CD-ROM, or any other storage medium which is known in the art. An exemplary storage medium is coupled to the processor 1100 and the processor 1100 may read information from the storage medium and write information in the storage medium. As another method, the storage medium may be integrated with the processor 1100. The processor and the storage medium may be stayed in an application specific integrated circuit (ASIC). The ASIC may be stayed in a user terminal. As another method, the processor and the storage medium may be stayed in a user terminal as individual components.

The specified matters and limited exemplary embodiments and drawings such as specific elements in the present invention have been disclosed for broader understanding of the present invention, but the present invention is not limited to the exemplary embodiments, and various modifications and changes are possible by those skilled in the art without departing from an essential characteristic of the present invention. Therefore, the spirit of the present invention is defined by the appended claims rather than by the description preceding them, and all changes and modifications that fall within metes and bounds of the claims, or equivalents of such metes and bounds are therefore intended to be embraced by the range of the spirit of the present invention.

What is claimed is:

1. A motion inquiry based searching method in a motion inquiry based searching service device, the method comprising:
storing video data for a plurality of contents and search reference information in a database;
analyzing the input motion inquiry video to extract position information for joints of an inquirer in every video frame;
extracting a representative posture describer of the inquirer for every section based on posture describers extracted from the position information for joints of the inquirer;
extracting the representative posture describer of contents for every point section referring to the search reference information; and
comparing the representative posture describer of the inquirer for every section with the representative posture describer of contents for every point section to calculate the similarity and extracting contents including a motion video having the highest similarity from the database.

2. The method of claim 1, wherein the motion inquiry video includes a three-dimensional depth video and the position information for joints includes three-dimensional position information.

3. The method of claim 1, wherein the search reference information includes position information for joints of a choreographer in the video frame.

4. The method of claim 3, wherein the search reference information further includes a choreographer posture describer in each video frame for a predetermined every point section and a representative posture describer for the every point section.

5. The method of claim 1, wherein the posture describer includes a set of relative angle information between joints.

6. The method of claim 1, wherein in the extracting of a representative posture describer of contents for every point section, in order to adjust the joints, the posture describers for contents are extracted and the representative posture describer of contents for every point section is extracted after extracting the position information of joints corresponding to each joint in the database, based on the data amount of position information for the joints of the inquirer.

7. The method of claim 1, further comprising:
displaying a content list which is arranged in the order of ranking of similarity on a display device according to the similarity.

8. The method of claim 1, wherein the similarity S is calculated using Equation S=αPS+(1−α) OS, based on a similarity PS of a posture and a similarity OS of the posture matching order and α is a weight which is set in advance.

9. The method of claim 8, wherein the similarity PS of a posture is calculated using a value adding the highest similarity among the representative posture describers of contents for every point section for the representative posture describers of the inquirer for every section, and the similarity OS of the posture matching order is calculated using an index based on the order of representative posture describer among representative posture describers of the contents for every point section which matches by the highest similarity, for every representative posture describer of the inquirer for every section.

10. A motion inquiry based searching service device, comprising:
a data base which stores video data for a plurality of contents and search reference information;
a human joint extracting unit which analyzes the input motion inquiry video to extract position information for joints of an inquirer in every video frame;
a motion feature extracting unit which extracts a representative posture describer of the inquirer for every section based on posture describers extracted from the position information for joints of the inquirer and extracts the representative posture describer of contents for every point section referring to the search reference information; and
a searching unit which compares the representative posture describer of the inquirer for every section with the representative posture describer of contents for every point section to calculate the similarity and extracts contents including a motion video having the highest similarity from the database.

11. The system of claim 10, wherein the motion inquiry video includes a three-dimensional depth video and the position information for joints includes three-dimensional position information.

12. The system of claim 10, wherein the search reference information includes position information for joints of a choreographer in the video frame.

13. The system of claim 12, wherein the search reference information further includes a choreographer posture describer in each video frame for a predetermined every point section and a representative posture describer for the every point section.

14. The system of claim 10, wherein the posture describer includes a set of relative angle information between joints.

15. The system of claim 10, wherein in order to adjust the joints, the motion feature extracting unit extracts the posture describers for contents and extracts the representative posture describer of contents for every point section after extracting the position information of joints corresponding to each joint in the database, based on the data amount of position information for the joints of the inquirer.

16. The system of claim 10, further comprising:
a searching result interface which displays a content list which is arranged in the order of ranking of similarity on a display device according to the similarity.

17. The system of claim 10, wherein the similarity S is calculated using Equation S=αPS+(1−α) OS, based on a similarity PS of a posture and a similarity OS of the posture matching order and α is a weight which is set in advance.

18. The system of claim 17, wherein the similarity PS of a posture is calculated using a value adding the highest similarity among the representative posture describers of contents for every point section for the representative posture describers of the inquirer for every section, and the similarity OS of the posture matching order is calculated using an index based on the order of representative posture describer among representative posture describers of the contents for every point section which matches by the highest similarity, for every representative posture describer of the inquirer for every section.
